(19) United States
(12) Patent Application Publication
(10) Pub. No.: US 2024/0232907 A1
(43) Pub. Date: Jul. 11, 2024

(54) BROKERAGE TRANSACTION SYSTEM FOR ENERGY EFFICIENCY BUSINESS

(71) Applicant: TERA PLATFORM INC., Seoul (KR)

(72) Inventors: Cheonseok SEO, Seoul (KR); Jaihwa PARK, Seoul (KR); Dalhoy KWON, Gyeonggi-do (KR)

(21) Appl. No.: 17/928,027

(22) PCT Filed: Dec. 29, 2021
(86) PCT No.: PCT/KR2021/020179

§ 371 Date: Nov. 28, 2022

(51) Int. Cl. G06Q 30/018; G06Q 30/0283

(52) U.S. Cl. CPC G06Q 30/018; G06Q 30/0283

(57) ABSTRACT

The present disclosure provides a brokerage system for an energy efficiency business that includes: a data collection device installed at target company and collecting energy saving data including energy saving information; and a brokerage server including a data receiver receiving data from the data collection device, a data storage storing the received data, and a point assigner calculating a point corresponding to an energy saving amount on the basis of data for a first period, and assigning the point to the target company.

### BACKGROUND OF THE INVENTION

### Field of the Invention

The present disclosure relates to a brokerage system for an energy efficiency business, in more detail, a brokerage system for activating an energy efficiency business by inspiring a desire for participation of target companies.

### Description of the Related Art

As more energy (particularly, fossil fuel) is used since the beginning of the industrial society, greenhouse gas emissions are increasing and the seriousness of various climate changes such as various unusual changes of weather, the rise in sea level, and desertification due to global warming by greenhouse gases are rising as an international issue.

In Korea, a demand management investment project that manages demands for energy is progressing to reduce demands and emission of greenhouse gases, and the field of efficiency improvement related to energy saving is mostly performed by ESCOs.

As a relevant patent, a trading and compensating method for saved energy has been disclosed in Korean Patent Application Publication No. 10-2010-0103265. This patent discloses a trading method for saved energy that receives power usage of a target company in real time, calculates a power saving amount on the basis of the power usage, measures the power saving amount into a greenhouse gas emission right, transmits the greenhouse gas emission right to a greenhouse gas verification authority, and receives a greenhouse gas emission right authenticated by an authentication authority.

In this patent, a configuration of calculating a power saving amount and receives an emission right on the basis of real-time power uses has been disclosed, but power usage data over at least one year, generally, three years are needed to refund an energy saving amount as an emission right under the present system, so it is impossible to acquire an emission right on the basis of only real-time power usage data for a short period of time without changing the system.

A target company cannot receive realistic profits for energy saving measures until its business period ends, and has to keep performing a troublesome formal procedure for energy saving amount authentication. Accordingly, preference for an energy efficiency business of companies decreases, which may impede activation of the energy efficiency business.

### SUMMARY OF THE INVENTION

The present disclosure has been made in an effort to solve the problems described above and an objective of the present disclosure is to provide a brokerage system for an energy efficiency business for activating an energy efficiency business.

A brokerage system for an energy efficiency business according to an embodiment of the present disclosure includes: a data collection device installed at target company and collecting energy saving data including energy saving information; and a brokerage server including a data receiver receiving energy saving data from the data collection device, a data storage storing the received energy saving data, and a point assigner calculating a point corresponding to an energy saving amount for a first period and assigning the point to the target company.

Further, in an embodiment, the brokerage server includes: a report creator creating an energy saving report on the basis of energy saving data for a second period longer than the first period; and an authenticator requesting authentication by sending the energy saving report to an energy saving authentication server.

Further, in an embodiment, the data collection device includes: a data collector collecting energy usage and output of the target company; and a data calculator calculating energy saving data on the basis of the collected energy usage and output.

Further, in an embodiment, the data collection device further includes a data determiner determining whether there is a problem with the energy saving data on the basis of the energy usage and the output, and notifying the target company and the brokerage server whether there is a problem with the data.

Further in an embodiment, when determining that there is a problem with the energy saving data, the data determiner notifies the target company and the brokerage server whether there is a problem with the data.

Further, in an embodiment, energy usage of the target company includes: first energy usage for a first facility group to which an energy efficiency business was applied, third energy usage for a third facility group that progresses the same process as that of the first facility group of a second facility group to which an energy efficiency business was not applied; and fourth energy usage for a fourth facility group that does not progress the same process as that of the first facility group of the second facility group to which an energy efficiency business was not applied. Output of the target company includes: output of the first facility group, third output of the third facility group and fourth output of the fourth facility group, and the problem determiner determines whether there is a problem with data on the basis of the first, third, and fourth energy usage and the first, third, and fourth output.

Further, in an embodiment, the point assigner calculates the price of an emission right corresponding to an energy saving amount for the first period, and assigns a point corresponding to the price of the emission right to the target company.

A brokerage server for an energy efficiency business according to an embodiment of the present disclosure includes: a data receiver receiving energy saving data including an energy saving amount from a data collection device installed at a target company; a data storage storing the received energy saving data; and a point assigner calculating a point corresponding to an energy saving amount for a first period and assigning the point to the target company.

Further, in an embodiment, the brokerage server further includes: a report creator creating an energy saving report on the basis of energy saving data for a second period longer than the first period; and an authentication requester requesting authentication by providing the energy saving report to an energy saving authentication server.

Further, in an embodiment, the point assigner estimates the price of an emission right corresponding to an energy saving amount for the first period, and assigns a point corresponding to the estimated price of the emission right to the target company.

Further, in an embodiment, the brokerage server further includes: a report creator creating an energy saving report on the basis of energy saving data for a second period longer than the first period; and an authenticator requesting authentication by sending the energy saving report to an energy saving authentication server.

According to the present disclosure, a target company that performed an energy efficiency business can be provided with a point that can be changed into cash at every predetermined period as the cost for an emission right rather than a brokerage server acquires the emission right that the target company will acquired in the future through energy saving, motivation about an energy efficiency business of target companies is induced, whereby it is possible to activate the energy efficiency business.

According to the present disclosure, since the data determiner determines whether there is a problem with an energy saving data, wrong assignment due to a problem with energy saving data is prevented, so it is possible to reduce a risk on the provider that operates the brokerage server.

### BRIEF DESCRIPTION OF THE DRAWINGS

The above and other objectives, features and other advantages of the present invention will be more clearly understood from the following detailed description when taken in conjunction with the accompanying drawings, in which:

FIG. 1 is a view for describing a brokerage system for an energy efficiency business according to an embodiment of the present disclosure;

FIG. 2 is a view for describing a brokerage server shown in FIG. 1;

FIG. 3 is a view for describing a data collection device shown in FIG. 1; and

FIG. 4 is a view for describing a method of determining whether there is a problem with data by means of a dater determiner shown in FIG. 3.

### DETAILED DESCRIPTION OF THE INVENTION

Embodiments of the present disclosure will be described hereafter in detail with reference to the accompanying drawings.

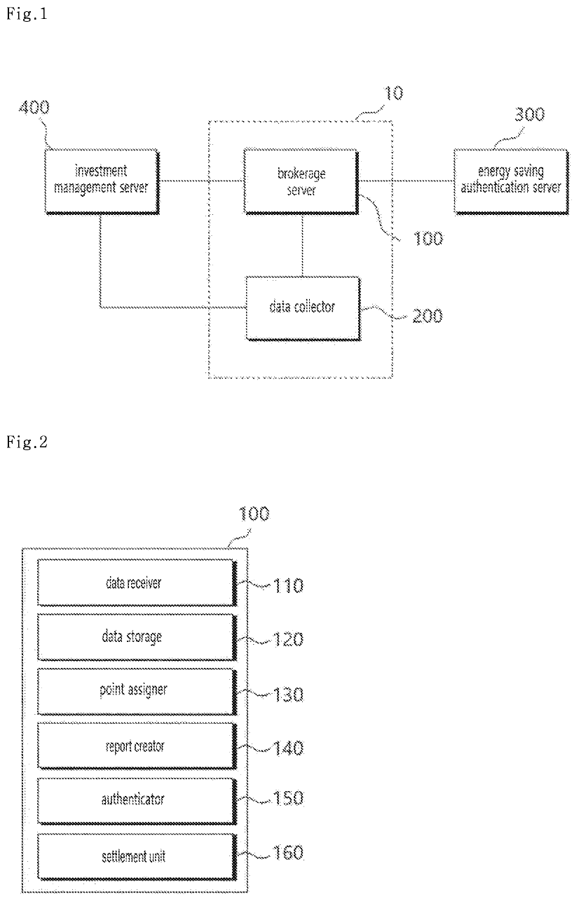

FIG. 1 is a view for describing a brokerage system for an energy efficiency business according to an embodiment of the present disclosure.

According to a brokerage system for an energy efficiency business of the present disclosure, a brokerage server acquires an emission right that a target company, which performed an energy efficiency business, will acquire in the future through energy saving, and the target company is provided with a point that can be changed into cash at every predetermined period in compensation for the emission right.

The brokerage system 100 is a system that is operated by an ESCO that registered for a program reduction business and the target company may be a company that made a contract of being paid in advance an emission right as a point. The investment management server 400 is a server that is operated by at least one investor.

When an ESCO and an investor progressed an energy efficiency improvement project for a target company, the energy saving money for the business period belong to the ESCO and the investor, and when the business period ends, the energy saving money belong to the target company.

FIG. 1 shows that one data collection device 200 is installed at a target company, but when there is a plurality of target companies, the data collection device may be provided by the number corresponding to the target company, and a plurality of data collection devices may be provided for each target company.

It is assumed that an energy efficiency business was applied to a first facility group of a company may include a second facility group to which the energy efficiency business is not applied besides the first facility group, and the second facility group may include a third facility group that progresses the same process with that of the first facility group, and a fourth facility group that does not progress the same process with that of the first facility group.

Referring to FIG. 1, the brokerage system 10 of the present disclosure includes a brokerage server 100 and a data collection device 200.

The brokerage server 100 receives and stores energy saving data including energy saving amount information from the data collection device 200, calculates and assigns a point corresponding to an energy saving amount for a first period to a target company on the basis of energy saving data for the first period, creates an energy saving report on the basis of energy saving data for two years, and requests authentication from an energy saving authentication server 300.

FIG. 2 is a view for describing a brokerage server shown in FIG. 1.

Referring to FIG. 2, the brokerage server 100 includes a data receiver 110, a data storage 120, a point assigner 130, a report creator 140, an authenticator 150, and a settlement unit 160.

The data receiver 110 receives energy saving data including energy saving amount information at every first period from the data collection device 210 installed in a target company.

The first period may be set in the unit of minute, hour, day, or moth. The first period may be set as a short period in comparison to a second period that is a minimum period required to external business authentication results.

The energy saving data are data including energy saving amount information that is calculated from equation 1 on the basis of first energy usage for the first facility group to which a energy efficiency business was applied, output for the first facility group, and past energy usage and past output of the first facility group before the energy efficiency business was applied to the first facility group.

The energy saving amount can be calculated as follows,

energy saving amount=first energy usage for first facility group before energy efficiency business is applied−first energy usage for first facility group after energy efficiency business is applied+correction amount.

The correction amount is calculated on the basis of output before and after an energy efficiency business is applied, details of the equation related to a correction amount has been disclosed in IPMVP.

The data storage 120, which is a storage device, stores energy saving data that are received at every first period.

The point assigner 130 calculates a point to be provided to a target company on the basis of energy saving information included in first energy saving data, and assigns the calculated point to the company. The time at which a point is assigned to a company may be set as an integer multiple of the first period rather than the first period.

Meanwhile, in consideration of the error between the finally calculated energy saving amount and an energy saving amount actually authenticated later, it is possible to assign only a point excluding an error point corresponding to the error. The error point may be adjusted and paid later by the settlement unit 160.

For example, when an error that may be generated between a calculated energy saving amount and an actually authenticated energy saving amount is around 5%, a point of 95% excluding an error point corresponding to 5% can be assigned to a target company.

The target company can change the assigned point into cash through the investment management server 400. The investment management server 400 assigns the point to the brokerage server 100 and the brokerage server 100 assigns some of the point to the target company on the basis of the energy saving amount of the target company.

Accordingly, since the target company can obtain and change the point into cash, the interest in the energy efficiency business of other companies besides the target company increases, so the energy efficiency business can be activated.

The report creator 140 is based on a plurality of continuous first energy saving amount data of the target company that corresponds to the second period, and a report requested by the energy saving authentication server 300 follows a format such as International performance measurement and verification protocol (IPMVP). The report creator 140 may create an energy saving report itself by inputting additional information or may request a brokerage server provider to create a report.

The second period may be a period for which energy saving data for authentication of an emission right are accumulated. For example, the second period may be set in the unit of year such as 1 year, 3 years, and 5 years.

The authenticator 150 performs a function of requesting authentication by providing a report or transmitting a report by mail to the energy saving authentication server 300, and of receiving an emission right from the authentication server 300.

In this case, the emission right belongs to a delay system as the cost of the point paid to the target company and may be transferred to the investment management server as the cost of the point.

The settlement unit 160 provides the target company with a point corresponding to the difference between the cash value of the emission right acquired by the authenticator 150 and the cash value of the point paid to the target company. The difference is calculated on the basis of the data on which an external company authentication result is acquired, but is not limited thereto.

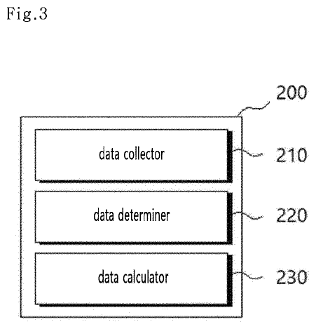

FIG. 3 is a view for describing a data collection device shown in FIG. 1.

An energy saving amount calculator 210 provides energy saving data to the energy receiver 110 of the brokerage server 100. The energy saving data are for quickly determining an energy saving amount for the first period that is the basis of assigning a point.

The energy saving amount calculator 200 includes a data collector 210, a data determiner 220, and a data calculator 230.

The data collector 210 can collect energy usage information for a first facility group M1 to which an energy efficiency business was applied.

The data collector 210 can collect energy usage information even for a second facility group M1 to which an energy efficiency business was applied. The second facility group M2 may third facility group M3 that progresses the same process as that of the first facility group M1, and a fourth facility group M4 that performs a different process such as a previous process or a following process.

Further, the data collector 210 is connected with a manufacturing execution system (MES) and a factory energy management system (FEMS) and can collect production-related information such as facility operation efficiency and facility output from the systems.

Further, the data collector 210 can determine whether there is a problem with data such as missing of data. When data are missing, the data collector 210 can perform again data collection.

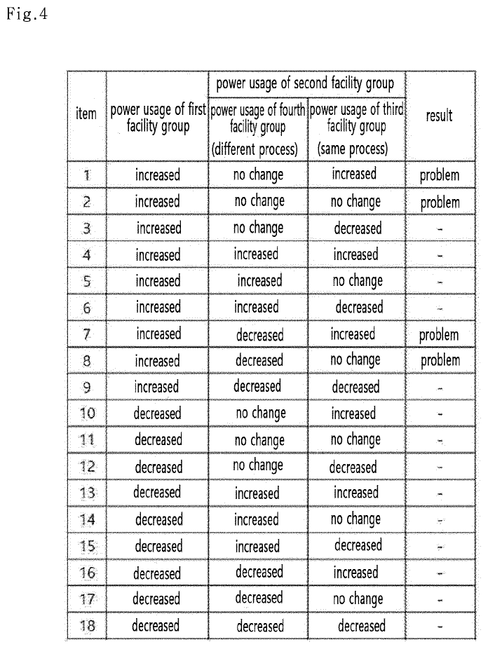

FIG. 4 is a view for describing a method of determining whether there is a problem with data by means of a dater determiner shown in FIG. 3.

In FIG. 4, fluctuation of power usage means whether the power usage at the current time point ‘t’ increased or decreased in comparison to power usage at a past time point.

The data determiner 220 can determine whether there is a problem with data in consideration of energy usage and output of each of a first facility group M1 to which an energy efficiency business was applied, a third facility group to which an energy efficiency business was not applied and that performs the same process, and a fourth facility group to which an energy efficiency business was not applied. The output means the number of times of processes at a facility group, and the fact that the fourth facility group progresses a different process means that the fourth facility group progresses a following process or a pervious process of the process that the first and third facility groups progress.

When the first facility group and the third facility group progress a first process and the fourth facility group progresses a second process, the number of time of the first process is generally proportioned to the number of times of a second process. Accordingly, when the number of time of the first process increases but the number of times of the second process decreases or when the number of time of the first process decreases but the number of times of the second process increases, it is possible to determine that there is a problem with energy saving data. The number of times of process corresponds to output and is proportioned to power usage.

For example, when the power usage of the first facility group and the third facility group shown in item 1 increases and the power usage of the fourth facility group that performs a following process or a pervious process of the process that the first and third facility groups progress does not change, it is possible to infer that there is no change in entire output due to no change in the power usage of the fourth facility group. However, since the power usage of the first facility group and the third facility group increases, it is possible to infer that the entire output increases.

The data determiner can determine that there is a problem with the energy saving data.

Similarly, in the states of an item 2, an item 7, and an item 8, the data determiner can determine that there is a problem with the energy saving data. The result of determining whether there is a problem shown in FIG. 4 is not fixed, and a different result of determining whether there is a problem may be applied to each company.

According to the present disclosure, since the data determiner determines whether there is a problem by comparing energy usage in different processes, and notifies a brokerage server user whether there is a problem with data, wrong assignment due to a problem with energy saving data is prevented, so it is possible to reduce a risk on the provider that operates the brokerage server.

When there is no problem with data, the data calculator 230 creates energy saving data on the basis of collected power usage information and provides the energy saving data to the data receiver 110 of the brokerage server 100.

The energy saving data are data that are calculated from equation 1 on the basis of first energy usage for the first facility group to which a energy efficiency business was applied, output for the first facility group, and past energy usage and past output of the first facility group before the energy efficiency business was applied to the first facility group, which is the same as that described in relation to the data receiver 110.

The energy saving authentication server 300 is a server that authenticates energy saving by analyzing a report, provides an emission right, and is operated by an authentication authority.

The investment management server 400 is a server that is operated by at least one investor or a computer of at least one investor. The investment management server 400 provides point to the brokerage server 100, and when there is a request for changing a point into cash, the investment management server 400 searches for the point assigned to the target company in the brokerage server 100 and provides the target company with cash corresponding to the point requested by the target company.

According to the present disclosure, a target company that performed an energy efficiency business can be provided with a point that can be changed into cash at every predetermined period as the cost for an emission right rather than a brokerage server acquires the emission right that the target company will acquired in the future through energy saving, motivation about an energy efficiency business of target companies is induced, whereby it is possible to activate the energy efficiency business.

According to the present disclosure, since the data determiner determines whether there is a problem with an energy saving data, wrong assignment due to a problem with energy saving data is prevented, so it is possible to reduce a risk on the provider that operates the brokerage server.

Meanwhile, various embodiments of the present disclosure described above may be implemented as a computer-readable recording medium or a program stored in a recording medium. The recording medium includes a storage medium that stores computer-readable data.

Various embodiments of the present disclosure may be implemented by combining hardware and software. As hardware, a processor may include a nonvolatile memory in which computer programs that are software are stored, a RAM on which computer programs stored in a nonvolatile memory are loaded, and a CPU that executes computer programs loaded on a RAM. The nonvolatile memory includes a hard disk drive, a flash memory, a ROM, CD-ROMs, magnetic tapes, a floppy disc, and an optical storage, but is not limited thereto. The nonvolatile memory is an example as a computer-readable recording medium of the present disclosure.

What is claimed is:

1. A brokerage system for an energy efficiency business, comprising:
a data collection device installed at target company and collecting energy saving data including energy saving information; and
a brokerage server including a data receiver receiving energy saving data from the data collection device, a data storage storing the received energy saving data, and a point assigner calculating a point corresponding to an energy saving amount for a first period and assigning the point to the target company.

2. The brokerage system of claim 1, wherein the brokerage server includes:
a report creator creating an energy saving report on the basis of energy saving data for a second period longer than the first period; and
an authenticator requesting authentication by sending the energy saving report to an energy saving authentication server.

3. The brokerage system of claim 1, wherein the data collection device includes:
a data collector collecting energy usage and output of the target company; and
a data calculator calculating energy saving data on the basis of the collected energy usage and output.

4. The brokerage system of claim 3, wherein the data collection device further includes a data determiner determining whether there is a problem with the energy saving data on the basis of the energy usage and the output.

5. The brokerage system of claim 3, wherein when determining that there is a problem with the energy saving data, the data determiner notifies the target company and the brokerage server whether there is a problem with the data.

6. The brokerage system of claim 4, wherein the data determiner determines whether there is a problem with data on the basis of energy usage and output for each of a first facility group to which an energy efficiency business was applied, a third facility group that progresses the same process as that of the first facility group of a second facility group to which an energy efficiency business was not applied, and a fourth facility group that does not progress the same process as that of the first facility group of the second facility group to which an energy efficiency business was not applied.

7. The brokerage system of claim 1, wherein the point assigner calculates the price of an emission right corresponding to an energy saving amount for the first period, and assigns a point corresponding to the price of the emission right to the target company.

8. A brokerage server for an energy efficiency business, comprising:
a data receiver receiving energy saving data including an energy saving amount from a data collection device installed at a target company;
a data storage storing the received energy saving data; and
a point assigner calculating a point corresponding to an energy saving amount for a first period and assigning the point to the target company.

9. The brokerage server of claim 8, further comprising:
a report creator creating an energy saving report on the basis of energy saving data for a second period longer than the first period; and
an authentication requester requesting authentication by providing the energy saving report to an energy saving authentication server.

10. The brokerage server of claim 8, wherein the point assigner estimates the price of an emission right corresponding to an energy saving amount for the first period, and assigns a point corresponding to the estimated price of the emission right to the target company.
